(19) United States
(12) Patent Application Publication
(10) Pub. No.: US 2025/0201891 A1
(43) Pub. Date: Jun. 19, 2025

(54) SECONDARY BATTERY MANUFACTURING EQUIPMENT AND SECONDARY BATTERY MANUFACTURED THEREBY

(71) Applicant: Samsung SDI Co., Ltd., Yongin-si (KR)

(72) Inventors: Chang Hun CHO, Yongin-si (KR); Hyun Uk CHO, Yongin-si (KR); Sung Hu KIM, Yongin-si (KR); Jin Kyung PARK, Yongin-si (KR)

(21) Appl. No.: 18/661,446

(22) Filed: May 10, 2024

(30) Foreign Application Priority Data
Dec. 14, 2023 (KR) 10-2023-0181676

(51) Int. Cl. H01M 10/04; H01M 50/103; H01M 50/289

(52) U.S. Cl. CPC H01M 10/0404; H01M 10/0468; H01M 50/103; H01M 50/289

(57) ABSTRACT

The present disclosure provides secondary battery-manufacturing equipment including a guide jig configured to be adjacent a lower portion of an electrode assembly at a position at which the electrode assembly is to be inserted into a case, and configured to descend together with the electrode assembly, a driving unit configured to drive the guide jig, and a control unit configured to control the driving unit.

### CROSS-REFERENCE TO RELATED APPLICATION

The present application claims priority to and the benefit of Korean Patent Application No. 10-2023-0181676, filed on Dec. 14, 2023, in the Korean Intellectual Property Office, the entire disclosure of which is incorporated herein by reference.

### BACKGROUND

### 1. Field

One or more embodiments of the present disclosure relates to secondary battery-manufacturing equipment.

### 2. Description of the Related Art

Secondary batteries may include an electrode assembly stacked or wound with a separator interposed between a positive electrode plate and a negative electrode plate, a case accommodating the electrode assembly together with an electrolyte, and a cap assembly for sealing the case.

If a stack-type electrode assembly is inserted into a case, there is a relatively unsuitable risk of collision with the case depending on a bending direction of a stack. Although the extent is less than that of the stack-type electrode assembly, a wound-type electrode assembly may have a problem in which winding alignment is disturbed during moving. If a bent portion of the electrode assembly stack or an end portion of the misaligned electrode assembly collides with the case, a short circuit may be caused, and there may be a desire to improve the manufacturing processes to ensure that the electrode assembly is inserted without colliding with the case.

The above-described information serving as the background of the present disclosure is only for improving understanding of the background of the present disclosure, and may include information that does not constitute the related art.

### SUMMARY

One or more embodiments of the present disclosure relates to secondary battery-manufacturing equipment that improves manufacturing processes, that improves a process of inserting an electrode assembly into a case, and a secondary battery manufactured thereby.

One or more embodiments of the present disclosure may provide secondary battery-manufacturing equipment including a guide jig configured to be adjacent a lower portion of an electrode assembly at a position at which the electrode assembly is to be inserted into a case, and configured to descend together with the electrode assembly, a driving unit configured to drive the guide jig, and a control unit configured to control the driving unit.

The driving unit may include a first driving unit configured to move the guide jig in a direction toward the electrode assembly, and a second driving unit configured to move the guide jig in an insertion direction of the electrode assembly.

The guide jig may be spaced apart from the case by a gap at the position at which the electrode assembly is to be inserted into the case.

The guide jig may be configured to descend while the electrode assembly descends toward the case and while maintaining a separation gap between the guide jig and the electrode assembly.

The guide jig may be configured to descend at a speed that is substantially equal to a descending speed of the electrode assembly.

The guide jig may include a pair of first guide blocks respectively facing long side portions of the electrode assembly.

The separation gap between one of the first guide blocks and the electrode assembly may correspond to a value obtained by subtracting a width of the electrode assembly from a width of the case.

A gap between the first guide blocks may be less than or equal to the width of the case.

The guide jig may further include a pair of second guide blocks respectively facing short side portions of the electrode assembly.

A separation gap between one of the second guide blocks and the electrode assembly may correspond to a value obtained by subtracting a length of the electrode assembly from a length of the case.

A gap between the second guide blocks may be less than or equal to the length of the case.

The guide jig may have a diagonal or streamlined cross-section at a surface facing the electrode assembly.

An upper corner of the surface of the guide jig facing the electrode assembly may have a radius (R) value of about 5R to about 10R.

The guide jig may be configured to return to an original position after the electrode assembly is partially inserted into the case.

Further, one or more embodiments of the present disclosure may provide a secondary battery manufactured by the secondary battery-manufacturing equipment described above.

The electrode assembly may be a stack-type electrode assembly.

### BRIEF DESCRIPTION OF DRAWINGS

FIG. 1 is a perspective view illustrating a secondary battery.

FIG. 2 is a perspective view of a cap assembly and an electrode assembly according to FIG. 1.

FIG. 3 is a schematic view schematically illustrating a partial manufacturing process of the secondary battery according to one or more embodiments of the present disclosure.

FIG. 4 is a schematic view illustrating a guide jig fixed in the manufacturing process according to FIG. 3.

FIG. 5 is a schematic view illustrating an operation of a movable guide jig in the manufacturing process according to FIG. 3.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted. In the drawings, the relative sizes of elements, layers, and regions may be exaggerated for clarity and/or descriptive purposes.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure. The present disclosure covers all modifications, equivalents, and replacements within the idea and technical scope of the present disclosure. Further, each of the features of the various embodiments of the present disclosure may be combined with each other, in part or in whole, and technically various interlocking and driving are possible. Each embodiment may be implemented independently of each other or may be implemented together in an association.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

If one or more embodiments may be implemented differently, a specific process order may be performed differently from the described order. For example, two consecutively described processes may be performed substantially at the same time or performed in an order opposite to the described order.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, secondary battery-manufacturing equipment according to one or more embodiments of the present disclosure and a secondary battery manufactured thereby will be described in detail with reference to the accompanying drawings.

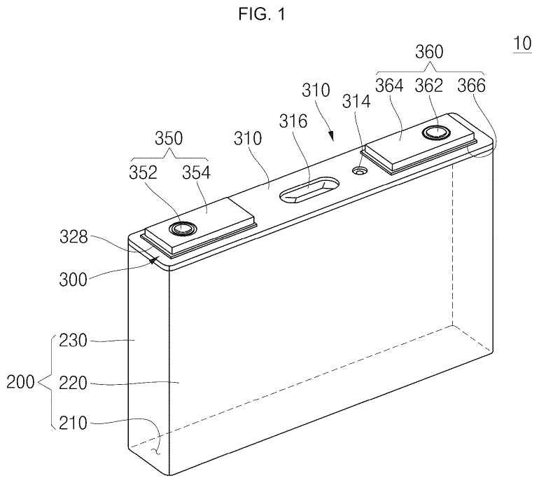

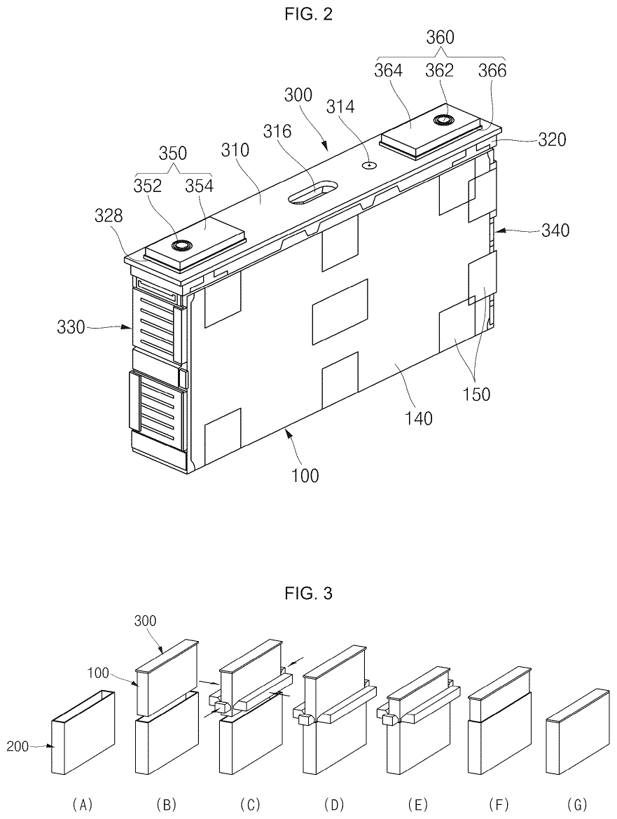

First, a structure of a secondary battery will be described. FIG. 1 is a perspective view illustrating the secondary battery. FIG. 2 is a perspective view of a cap assembly and an electrode assembly according to FIG. 1.

Referring to FIGS. 1 and 2, a secondary battery 10 according to one or more embodiments of the present disclosure may include an electrode assembly 100, a case 200 accommodating the electrode assembly 100, and a cap assembly 300 coupled to the case 200. As an example, the secondary battery 10 may be a prismatic type battery in which the case 200 has a rectangular parallelepiped shape.

Referring to FIG. 2, the electrode assembly 100 may be of a stacked type in a rectangular parallelepiped shape. The electrode assembly 100 may have a form in which a plurality of unit stacks, each of which being composed of thin plate-shaped or film-shaped first and second electrode plates and a separator interposed therebetween, are stacked. In the electrode assembly 100, the plurality of unit stacks may be located such that long side surfaces thereof contact each other. In one or more embodiments, the electrode assembly 100 may have a form in which a unit stack, which is composed of plate-shaped or film-shaped first and second electrode plates and a separator interposed therebetween, is wound. A sheet 140 of an insulating material may be attached to the outside of the electrode assembly 100 by an insulating tape 150 to insulate the electrode assembly 100 from the case 200. For example, the insulating sheet may be attached to a plate surface of the electrode assembly having a relatively large area. For example, side surfaces of the electrode assembly, which are stacked surfaces, may be fixed by the insulating tape. As an example, the first electrode plate may be a negative electrode, and the second electrode plate may be a positive electrode. In one or more embodiments, the reverse of the above description may be possible.

If the first electrode plate is a negative electrode plate, the first electrode plate may be formed by applying a first electrode active material, such as graphite or carbon, onto a first electrode current collector provided as a metal foil, such as copper, a copper alloy, nickel, or a nickel alloy. A first uncoated portion, which is a region to which the first electrode active material is not applied, may be formed on the first electrode plate. The first uncoated portion may be cut into uniform shapes to form first substrate tabs. A plurality of first substrate tabs may be bent to one side, and may be welded to a first current-collecting plate 330. The first current-collecting plate 330 may be electrically connected to the cap assembly 300.

If the second electrode plate is a positive electrode plate, the second electrode plate may be formed by applying a second electrode active material, such as a transition metal oxide, onto a second electrode current collector provided as a metal foil, such as aluminum or an aluminum alloy. A second uncoated portion, which is a region to which the second electrode active material is not applied, may be formed on the second electrode plate. The second uncoated portion may be cut into uniform shapes to form second substrate tabs. A plurality of second substrate tabs may be bent to one side, and may be welded to a second current-collecting plate 340. The second current-collecting plate 340 may be electrically connected to the cap assembly 300.

The separator is located between the first electrode plate and the second electrode plate to reduce or prevent the likelihood of a short circuit therebetween, and to allow the movement of lithium ions. As an example, the separator may include polyethylene, polypropylene, or a composite film of polyethylene and polypropylene. However, the present disclosure is not limited to the above-described materials.

The electrode assembly 100 having the above-described structure may be accommodated in the case 200 together with an electrolyte. In a partial manufacturing process of the secondary battery 10, the electrode assembly 100 may be inserted into the case 200 (which will be described later). In some examples, the electrolyte may include a lithium salt, such as LiPF₆ or LiBF₄, in an organic solvent, such as ethylene carbonate (EC), propylene carbonate (PC), diethyl carbonate (DEC), ethylmethyl carbonate (EMC), or dimethyl carbonate (DMC). The electrolyte may be in a liquid or gel phase. In some examples, if an inorganic solid electrolyte is used, the electrolyte may be omitted.

Referring to FIG. 1, the case 200 may be provided in the form of a substantially rectangular parallelepiped box, with an upper portion in a longitudinal direction open and an accommodation space formed inside. The electrode assembly 100 and the electrolyte may be accommodated in the case 200 through the open upper portion. Some components of the cap assembly 300 may be exposed to the outside of the case 200, and some other components may be accommodated inside the case 200. The case 200 may include a bottom surface 210 of a rectangular shape and four side surfaces connected to the bottom surface 210. Among the side surfaces, the surfaces having a relatively large area may be defined as a long side portion 220, and the surfaces having a relatively small area may be defined as a short side portion 230. As an example, the electrode assembly 100 may be located such that the plate surface thereof having a relatively large area faces the long side portion 220. For convenience of description, the plate surfaces of the electrode assembly facing the long side portions of the case may be defined as a long side portion, and the side surfaces of the electrode assembly facing the short side portions of the case may be defined as a short side portion. In a state in which the electrode assembly 100 is accommodated in the case 200, the cap assembly 300 is coupled to the case 200, and is electrically connected to the electrode assembly 100.

Referring to FIGS. 1 and 2, the cap assembly 300 may include a cap plate 310 coupled to the case 200, a plurality of insulating members, the first current-collecting plate 330, the second current-collecting plate 340, a first terminal portion 350, and a second terminal portion 360.

The cap plate 310 has a substantially rectangular plate shape, and may be formed of the same material as the case 200. The cap plate 310 may include terminal holes for respectively coupling the first terminal portion 350 and the second terminal portion 360, may include a liquid injection hole 314, and may include a vent hole for coupling a vent 316. In one or more embodiments, a plurality of insulating members, such as an insulating plate 320, may be provided to insulate the cap plate 310 from the electrode assembly 100.

The first current-collecting plate 330 electrically connects a first electrode plate 110, which is a negative electrode plate, to the first terminal portion 350. To this end, the first current-collecting plate 330 may be made of the same material as the first electrode plate 110. As an example, the first current-collecting plate 330 may be electrically connected to the first substrate tab of the first electrode plate 110 by laser welding. For the welding, the first substrate tabs may be gathered to one side, the first current-collecting plate 330 may be placed on the first substrate tabs, and then, end portions of the first substrate tabs may be bent over, and may be welded to the first current-collecting plate 330.

The second current-collecting plate 340 may be symmetrical with the first current-collecting plate 330, and may be electrically connected to a second electrode plate 120. To this end, the second current-collecting plate 340 may be made of the same material as the second substrate tab of the second electrode plate 120. For the welding, the second substrate tabs may be gathered to one side, the second current-collecting plate 340 may be placed on the second substrate tabs, and then, end portions of the second substrate tabs may be bent over, and may be welded to the second current-collecting plate 340.

The first terminal portion 350 may include a first terminal pin 352 and a first terminal plate 354. The first terminal plate 354 may be insulated from the cap plate 310 by an insulating member 328. The first terminal pin 352 may be electrically connected to the first electrode plate 110 of the electrode assembly 100 by being electrically connected to the first current-collecting plate 330.

The second terminal portion 360 may include a second terminal pin 362, a second terminal plate 364, and a conductive plate 366. The second terminal portion 360 may be symmetrical to the first terminal portion 350. The conductive plate 366 electrically connects the cap plate 310 to the second terminal plate 364 that is electrically connected to the second terminal pin 362. The cap plate 310 may be electrically connected to the second electrode plate 120, as the cap plate 310 may be connected to the second current-collecting plate 340 by the second terminal portion 360. The cap plate 310 may have a positive polarity, which is the same as the second current-collecting plate 340, and the case 200, which is welded to the cap plate 310, also may have a positive polarity.

Hereinafter, a partial process for manufacturing a secondary battery having the above-described structure will be described.

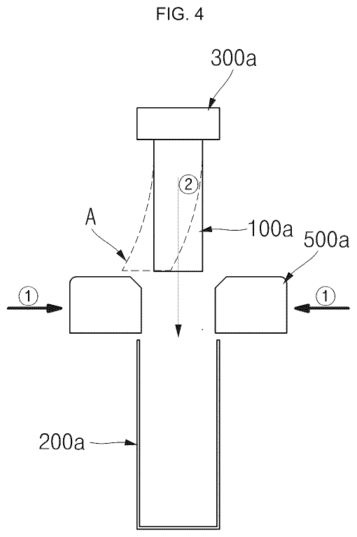

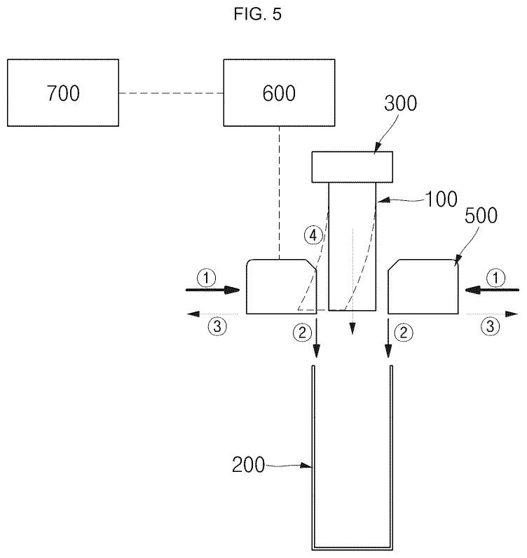

FIG. 3 is a schematic view schematically illustrating a partial manufacturing process of the secondary battery according to one or more embodiments of the present disclosure. FIG. 3 sequentially illustrates a process of inserting the electrode assembly 100 into the case 200. FIG. 4 is a schematic view illustrating a guide jig fixed in the manufacturing process according to FIG. 3. FIG. 5 is a schematic view illustrating an operation of a movable guide jig in the manufacturing process according to FIG. 3 (for convenience of description, devices for transferring or supporting the case or the electrode assembly may be omitted from the drawings).

Referring to FIG. 3, a guide jig 500 may include a pair of guide blocks, each of which may be movable, and may have a hexahedral shape. The guide jig 500 may guide the long side portions of the electrode assembly 100. In some examples, in the guide jig 500, a surface facing the electrode assembly 100 may have a diagonal or streamlined cross-section, or corners (e.g., corners in an insertion direction of the electrode assembly), which are adjacent to the surface, may have a streamlined shape having a radius (R) value, wherein 1R means the value corresponding to the arc when a circle with a radius of 1 mm is drawn. Such a shape(s) may guide the electrode assembly 100 toward the case 200 without being damaged if the electrode assembly 100 contacts the guide jig 500. As an example, the corners of the guide jig 500 may each have an R value of about 5R to about 10R.

As an example, the guide jig 500 may further include a pair of guide blocks for guiding the short side portions of the electrode assembly 100 corresponding to side surfaces of the electrode assembly 100. For example, the guide jig 500 may include four blocks, and each of which may have a hexahedral shape. The guide jig 500 may have a streamlined shape, or an oblique shape, at the surface facing the electrode assembly 100, and may have the corners adjacent to the corresponding surface. If the guide jig 500 is composed of four guide blocks, a length of the guide block facing the long side portion of the electrode assembly 100 may be greater than that of the guide block facing the short side portion of the electrode assembly 100.

Referring to FIG. 5, the guide jig 500 is driven by a driving unit 600 under the control of a control unit 700. The control unit 700 may control the driving unit 600 according to a program (e.g., a preset program), or may control the driving unit 600 to drive the guide jig 500 by determining a position of the electrode assembly 100 through sensors, in one or more embodiments. In the guide jig 500, the four blocks may be operated respectively by a plurality of driving units 600, or may be operated by one driving unit 600. As various known driving means may be applied to the driving unit 600 of the guide jig 500, a detailed description thereof will be omitted.

If the guide jig 500 is adjacent to the electrode assembly 100, a gap between a pair of guide blocks of the guide jig 500 facing the long side portions of the electrode assembly 100 (hereinafter referred to as first guide blocks) may be less than or equal to a width of the case 200. A separation gap between the first guide block and the electrode assembly 100 may correspond to a width difference between the case 200 and the electrode assembly 100 (in FIG. 5, the case and the electrode assembly are illustrated in a width direction). If the first guide blocks do not contact the electrode assembly 100, the separation gap may be further reduced. In one or more embodiments, a gap between a pair of guide blocks of the guide jig 500 facing the short side portions of the electrode assembly 100 (hereinafter referred to as second guide blocks) may be less than or equal to a length of the case 200. A separation gap between the second guide block and the electrode assembly 100 may correspond to a length difference between the case 200 and the electrode assembly 100. If the second guide blocks do not contact the electrode assembly 100, the separation gap may be further reduced.

The process of inserting the electrode assembly 100 into the case 200 may be performed in the following sequence.

Referring to FIG. 3, the case 200 may be first located in a normal position for insertion of the electrode assembly 100 (operation A). Thereafter, the electrode assembly 100 may be located above the case 200 (operation B). If the electrode assembly 100 is located above the case, the guide jig 500 of the present disclosure may move to a first position (operation C). The first position may be a position corresponding to a lower portion of the electrode assembly 100. For example, the guide jig 500 may move toward the electrode assembly 100. In the first position, the guide jig 500 may cover both a lower end and a part of a lower portion of the electrode assembly 100. In one or more embodiments, in the first position, the guide jig 500 may be spaced apart from the electrode assembly 100 by a gap (e.g., a predetermined gap, or the separation gap described above). Because this is before the electrode assembly 100 is inserted into the case 200, the guide jig 500 may also be spaced apart from the case 200.

Thereafter, the guide jig 500 may move to a second position, and at the same time, the electrode assembly 100 may descend toward the case 200 (operation D). The second position may be a position at which a lower end of the guide jig 500 is adjacent to, or contacts, an upper end of the case 200. For example, the guide jig 500 may descend together with the electrode assembly 100. To this end, the guide jig 500 may descend at about the same speed at which the electrode assembly 100 descends. A lower portion of the electrode assembly 100 may descend toward the case 200 without swaying due to the guide jig 500. In a state in which the guide jig 500 is completely moving to the second position, the electrode assembly 100 may continue to descend to be inserted into the case 200 (operation E). If about ⅓ to about ½ or more of the electrode assembly 100 in a height direction is inserted into the case 200, the guide jig 500 may return to its original position (operation F). Thereafter, the insertion of the electrode assembly 100 into the case 200 is completed (operation G).

If a guide jig 500a does not guide a lower portion of an electrode assembly 100a as described above, the electrode assembly 100a may collide with the guide jig 500a.

FIG. 4 illustrates a comparative example in which the guide jig 500a is fixed to an upper end position of a case 200a. If the electrode assembly 100a is a stack-type electrode assembly, and if the electrode assembly 100a moves, the electrode assembly 100a may sway in a width direction of the case 200a (e.g., a width direction of a cap assembly 300a), as shown in FIG. 4. If the electrode assembly 100a sways and collides with the guide jig 500a (see portion A of FIG. 4), damage to the electrode assembly 100a may occur. A problem in which stacking alignment of the electrode assembly 100a is disturbed may occur. If the electrode assembly 100a is a wound-type electrode assembly, although the extent may be less than that of the stack-type electrode assembly, a problem in which winding alignment is disturbed may occur if the electrode assembly 100a moves.

To reduce or prevent the likelihood of this problem occurring, as described above, the guide jig 500 moves in response to the movement of the electrode assembly 100.

Referring to FIG. 5, the sequence of operations of the guide jig 500 may follow the numbered sequence shown in FIG. 5. If the electrode assembly 100 is located above the case 200, the guide jig 500 may move toward the lower portion of the electrode assembly 100 (e.g., may move in direction \hat{1} that is substantially perpendicular to the insertion direction of the electrode assembly). Thereafter, the guide jig 500 may descend together with the electrode assembly 100 (e.g., may move in direction \hat{2} that is substantially the same direction as the insertion direction of the electrode assembly) while maintaining a state of being adjacent to the lower portion of the electrode assembly 100. The driving unit 600 may include a first driving unit configured to move the guide jig 500 in left and right directions (e.g., in direction \hat{1} and in direction \hat{3} of FIG. 5), and may include a second driving unit configured to move the guide jig 500 in up and down directions (e.g., in direction \hat{2} of FIG. 5). Finally, the guide jig 500 may return to its original position (e.g., may move in direction \hat{3} that is substantially perpendicular to the insertion direction of the electrode assembly) if the electrode assembly 100 is inserted into the case 200 to some extent.

As described above, because the guide jig guides the electrode assembly while moving according to the movement and insertion operation of the electrode assembly, the electrode assembly can be inserted into the case without colliding with the guide jig. It may be possible to reduce or prevent the likelihood of a defect caused by damage to the electrode assembly in an electrode assembly insertion process, to improve manufacturing efficiency, and to reduce manufacturing costs.

According to one or more embodiments of the present disclosure, the likelihood of a collision between an electrode assembly and a case can be reduced or prevented during insertion of the electrode assembly into the case. It may be possible to reduce or prevent the likelihood of a defect caused by damage to the electrode assembly in an electrode assembly insertion process, to improve manufacturing efficiency, and to reduce manufacturing costs.

The above description is only one or more embodiments for implementing the present disclosure, and the present disclosure is not limited to the above-described embodiments. As claimed in the following claims, with functional equivalents thereof to be included therein, the present disclosure includes the scope in which various changes can be made by anyone skilled in the art without departing from the gist of the present disclosure.

What is claimed is:

1. Secondary battery-manufacturing equipment comprising:
a guide jig configured to be adjacent a lower portion of an electrode assembly at a position at which the electrode assembly is to be inserted into a case, and configured to descend together with the electrode assembly;
a driving unit configured to drive the guide jig; and
a control unit configured to control the driving unit.

2. The secondary battery-manufacturing equipment as claimed in claim 1, wherein the driving unit comprises a first driving unit configured to move the guide jig in a direction toward the electrode assembly, and a second driving unit configured to move the guide jig in an insertion direction of the electrode assembly.

3. The secondary battery-manufacturing equipment as claimed in claim 2, wherein the guide jig is spaced apart from the case by a gap at the position at which the electrode assembly is to be inserted into the case.

4. The secondary battery-manufacturing equipment as claimed in claim 3, wherein the guide jig is configured to descend while the electrode assembly descends toward the case and while maintaining a separation gap between the guide jig and the electrode assembly.

5. The secondary battery-manufacturing equipment as claimed in claim 4, wherein the guide jig is configured to descend at a speed that is substantially equal to a descending speed of the electrode assembly.

6. The secondary battery-manufacturing equipment as claimed in claim 5, wherein the guide jig comprises a pair of first guide blocks respectively facing long side portions of the electrode assembly.

7. The secondary battery-manufacturing equipment as claimed in claim 6, wherein the separation gap between one of the first guide blocks and the electrode assembly corresponds to a value obtained by subtracting a width of the electrode assembly from a width of the case.

8. The secondary battery-manufacturing equipment as claimed in claim 7, wherein a gap between the first guide blocks is less than or equal to the width of the case.

9. The secondary battery-manufacturing equipment as claimed in claim 8, wherein the guide jig further comprises a pair of second guide blocks respectively facing short side portions of the electrode assembly.

10. The secondary battery-manufacturing equipment as claimed in claim 9, wherein a separation gap between one of the second guide blocks and the electrode assembly corresponds to a value obtained by subtracting a length of the electrode assembly from a length of the case.

11. The secondary battery-manufacturing equipment as claimed in claim 10, wherein a gap between the second guide blocks is less than or equal to the length of the case.

12. The secondary battery-manufacturing equipment as claimed in claim 11, wherein the guide jig has a diagonal or streamlined cross-section at a surface facing the electrode assembly.

13. The secondary battery-manufacturing equipment as claimed in claim 12, wherein an upper corner of the surface of the guide jig facing the electrode assembly has a radius (R) value of about 5R to about 10R.

14. The secondary battery-manufacturing equipment as claimed in claim 12, wherein the guide jig is configured to return to an original position after the electrode assembly is partially inserted into the case.

15. A secondary battery manufactured by the secondary battery-manufacturing equipment as claimed in claim 1.

16. The secondary battery as claimed in claim 15, wherein the electrode assembly comprises a stack-type electrode assembly.
